(19) United States
(12) Patent Application Publication
(10) Pub. No.: US 2026/0364578 A1
(43) Pub. Date: Nov. 19, 2026

(54) PHOTOCATALYTIC CO2 CONVERSION VIA HYDROGENATION WITH CO-CATALYST-DECORATED NANOSTRUCTURES

(71) Applicants: Ke Yang, Ann Arbor, MI (US); Victor Batista, Ann Arbor, MI (US); The Regents of the University of Michigan, Ann Arbor, MI (US)

(72) Inventors: Zhengwei Ye, Ann Arbor, MI (US); Zetian Mi, Ann Arbor, MI (US); Ke Yang, New Haven, CT (US); Victor Batista, New Haven, CT (US)

(21) Appl. No.: 19/121,031

(22) PCT Filed: Oct. 16, 2023
(86) PCT No.: PCT/US2023/035227

§ 371 Date: Apr. 14, 2025

Related U.S. Application Data
(60) Provisional application No. 63/416,319, filed on Oct. 14, 2022.

(51) Int. Cl. B01J 23/89; B01J 35/30; B01J 35/33; B01J 35/39; B01J 37/02

(52) U.S. Cl. CPC B01J 23/8993; B01J 35/33; B01J 35/39; B01J 35/397; B01J 37/0215; B01J 2235/30

(57) ABSTRACT

A catalytic device includes a substrate and an array of conductive projections supported by the substrate and extending outward from the substrate. Each conductive projection of the array of conductive projections is decorated with a co-catalyst arrangement, the co-catalyst arrangement being configured to convert carbon dioxide (CO₂) via hydrogenation in aqueous solution.

### CROSS-REFERENCE TO RELATED APPLICATION

This application claims the benefit of U.S. provisional application entitled “Photocatalytic CO2 Conversion via Hydrogenation with Co-Catalyst-Decorated Nanostructures,” filed Oct. 14, 2022, and assigned Ser. No. 63/416,319, the entire disclosure of which is hereby expressly incorporated by reference.

### STATEMENT REGARDING FEDERALLY SPONSORED RESEARCH OR DEVELOPMENT

This invention was made with government support under Contract No. W911NF-21-1-0337 awarded by U.S. Army Research Office. The government has certain rights in the invention.

### BACKGROUND OF THE DISCLOSURE

### Field of the Disclosure

The disclosure relates generally to catalytic conversion of carbon dioxide (CO₂).

### Brief Description of Related Technology

Solar light conversion of CO₂ into liquid fuels such as methanol and ethanol can provide a viable solution to renewable energy production and mitigation of greenhouse gases. To date, current strategies for CO₂ conversion rely mainly on thermocatalysis and electrocatalysis, which consume a significant amount of thermal energy or electricity.

Solar light photocatalysis can offer a more sustainable approach. The main outstanding challenges include: (1) high-efficiency of CO₂ reduction, and (2) high product selectivity toward liquid fuels. Semiconductor materials with a large band gap can provide energetic carriers to reduce CO₂, however, they unavoidably suffered from a limited light response range. Furthermore, CO₂ reduction toward CO is often more favorable than conversion toward liquid fuels.

Recently, theoretical and experimental studies have suggested the importance of intermediates with different binding modes in controlling the efficiency, selectivity, and reaction rates during CO₂ reduction. In fact, it has been suggested that *COOH is a key intermediate in the formation of CO and following hydrocarbon products, while HCOO* is a key intermediate in the formation of HCOOH. Therefore, tuning the relative stability of reaction intermediates can favor a specific pathway and improve product selectivity during CO₂ reduction.

In nature, metalloenzymes, like the photosynthetic ribulose bisphosphate carboxylase (RuBisCO) and formate dehydrogenases of methylotrophic yeast and bacteria, can reduce CO₂ with high selectivity toward specific products. For example, Mo— and W— dependent formate dehydrogenases (FDH) can reversibly catalyze CO₂ reduction to formate.

### SUMMARY OF THE DISCLOSURE

In accordance with one aspect of the disclosure, a catalytic device includes a substrate and an array of conductive projections supported by the substrate and extending outward from the substrate. Each conductive projection of the array of conductive projections is decorated with a co-catalyst arrangement, the co-catalyst arrangement being configured to convert carbon dioxide (CO₂) via hydrogenation in aqueous solution.

In accordance with another aspect of the disclosure, a catalytic device includes a substrate and an array of conductive projections supported by the substrate and extending outward from the substrate. Each conductive projection of the array of conductive projections is decorated with a co-catalyst arrangement. The co-catalyst arrangement includes a first metallic nanoparticle, a second metallic nanoparticle adjacent the first nanoparticle, the second nanoparticle having a different composition than the first metallic nanoparticle, and an oxide shell covering an outer surface of the first metallic nanoparticle and exposing an outer surface of the second metallic nanoparticle.

In accordance with yet another aspect of the disclosure, a method of fabricating a photocatalytic device includes providing a substrate having a surface, forming an array of conductive projections on the substrate such that each conductive projection of the array of conductive projections extends outward from the substrate, each conductive projection of the array of conductive projections having a semiconductor composition configured for charge carrier generation in response to light radiation, and decorating each conductive projection of the array of conductive projections with a co-catalyst arrangement. Decorating each conductive projection includes depositing first metallic nanoparticles, second metallic nanoparticles, and an oxide material on each conductive projection to dispose the co-catalyst arrangement in a core-shell configuration.

In accordance with still another aspect of the disclosure, a photocatalytic device includes a substrate and an array of conductive projections supported by the substrate and extending outward from the substrate, each conductive projection of the array of conductive projections having a composition configured for charge carrier generation in response to light irradiation. Each conductive projection of the array of conductive projections is decorated with a co-catalyst arrangement, the co-catalyst arrangement being configured to convert carbon dioxide (CO₂) via hydrogenation in connection with the light irradiation.

In connection with any one of the aforementioned aspects, the devices and/or methods described herein may alternatively or additionally include or involve any combination of one or more of the following aspects or features. The co-catalyst arrangement has a bi-metallic composition. The co-catalyst arrangement is disposed in a core-shell configuration. The co-catalyst arrangement includes a first metallic nanoparticle, a second metallic nanoparticle adjacent the first nanoparticle, the second nanoparticle having a different composition than the first metallic nanoparticle, and an oxide shell covering an outer surface of the first metallic nanoparticle. The oxide shell is configured to allow the carbon dioxide (CO) to reach an outer surface of the second metallic nanoparticle. The oxide shell does not cover the outer surface of the second metallic nanoparticle. The first metallic nanoparticle includes a first metal. The second metallic nanoparticle includes a second metal. The second metal has a larger lattice mismatch with an oxide material of the oxide shell than the first metal. The first metallic nanoparticle is configured to reduce protons in the aqueous solution to hydrogen atoms. The first metallic nanoparticle and the second metallic nanoparticle are arranged such that the hydrogen atoms diffuse from the first metallic nanoparticle to the second metallic nanoparticle to hydrogenate the carbon dioxide (CO₂) present at the outer surface of the second metallic nanoparticle. The first metallic nanoparticle includes rhodium. The second metallic nanoparticle includes copper.

The oxide shell includes chromium oxide. Each conductive projection of the array of conductive projections has a semiconductor composition. The semiconductor composition is configured for charge carrier generation in response to solar radiation. The semiconductor composition includes a III-nitride semiconductor material. A method of using any one of the catalytic devices described herein includes immersing the catalytic device in the aqueous solution, illuminating the catalytic device with incident light radiation, and capturing a liquid product of a CO₂ reduction reaction catalyzed by the catalytic device. The aqueous solution is unheated. The catalytic device is illuminated without application of a bias voltage to the catalytic device. The aqueous solution is free of a sacrificial agent for the CO2 reduction reaction. Immersing the catalytic device in the aqueous solution is implemented at a temperature less than 200 degrees Celsius. The first metallic nanoparticle includes a first metal. The second metallic nanoparticle includes a second metal. The second metal has a larger lattice mismatch with an oxide material of the oxide shell than the first metal such that the oxide shell does not cover the second metallic nanoparticle. The first metallic nanoparticle includes rhodium. The second metallic nanoparticle includes copper. The oxide shell includes chromium oxide. Depositing the first metallic nanoparticles, the second metallic nanoparticles, and the oxide material includes implementing a photo-deposition procedure. Forming the array of conductive projections includes growing the array of conductive projections under a nitrogen-rich environment.

### BRIEF DESCRIPTION OF THE DRAWING FIGURES

For a more complete understanding of the disclosure, reference should be made to the following detailed description and accompanying drawing figures, in which like reference numerals identify like elements in the figures.

FIG. 1 is a schematic view of a photocatalytic device having a co-catalyst arrangement for hydrogenation-based conversion of carbon dioxide (CO₂) in accordance with one example.

FIG. 2 is a flow diagram of a method of fabricating a photocatalytic device having a co-catalyst arrangement for hydrogenation-based conversion of carbon dioxide (CO₂) in accordance with one example.

FIG. 3 depicts a schematic view of a photochemical architecture for artificial photosynthesis of methanol from carbon dioxide and water for highly selective of CO₂ reduction toward CH₃OH in accordance with one example.

FIG. 4 depicts schematic views of a) band alignment of the conduction and valence bands of GaN, work functions of Cu and Rh, and absolute redox potentials; b) GaN(101) and Rh(111) interface; c) Rh(111) and CrOOH (001) interface; d) preferred pathways of CO2 reduction by surface H atoms and e⁻ and H⁺ on the Cu(111) surface (relative energies in the unit of eV using H₂+CO₂ and bare Cu surfaces as the zero-reference), in which white, black, light blue, red, green, brown, blue, and grey spheres represent H, C, N, O, Ga, Cr, Cu, and Rh atoms, respectively.

FIG. 5 depicts synthesis and characterization of Rh/Cu/CrOOH@GalnN photocatalysts, including a) 45° tilted-SEM image of GalnN nanowires grown on Si wafer after photo deposition of Rh, Cr, and Cu co-catalysts; b), c) HAADF-STEM image; d) Schematic illustration of the reaction mechanism, including charge carrier generation upon photon excitation of GalnN, electron migration to Rh, hydrogen spillover from Rh to Cu, and CO₂ reduction to CH₃OH on Cu surface. e), f), g), h), Elemental mapping images of Rh/Cu/CrOOH@GalnN, with Ga, green; N, silver; Cu, blue; Rh, beige; Cr, orange; O, red; C, black; and H, white, as well as high-resolution XPS spectra of Rh 3d, i), Cu 2p, j) and Cr 2p, k) loaded on GalnN nanowire arrays before (upper panel) and after (lower panel) photocatalysis reaction, in which the grey symbols and curves represent the original data and fitting results of Rh 3d, Cu 2p and Cr 2p, respectively. Shown in i), the orange area represents the metal state of the rhodium while the grey area represents the oxygen adsorption on rhodium surface. a. u. denotes arbitrary units

FIG. 6 depicts photocatalytic performance of a Rh/Cu/CrOOH@GalnN architecture in accordance with one example, including a) production rates of CH₃OH, CH₄, H₂, and O₂ on (from left to right) GalnN nanowires, Cu/GalnN, Rh/GalnN, RhCr/GalnN, RhCu/GalnN, CrCu/GalnN, and RhRuCr/GalnN; b) variations of methanol selectivity (left axis) vs. co-catalyst deposition conditions. The production rates of methanol and hydrogen are shown in the right axis. Here 20:2 means 20 μL of Rh precursor and 2 μL Cu precursor were used in the photoadaptation process, c) methanol production under optimized co-catalyst conditions during twelve cycles of measurements. Each cycle lasted for one hour. After each cycle, the solution was removed and refilled, and the sample was taken out of the reaction chamber and rinsed by deionized water to remove the potentially attached methanol molecules. Experimental conditions: 50 mL deionized water, CO₂, 300 W Xenon-lamp, 3.5 W/cm², AM 1.5G+400 nm long pass filter. d) GC-MS spectrum of 18-oxygen generated during the CO₂ reduction reaction with 18-O labelled water. e) NMR H-spectrum of ¹²C methanol generated during the CO₂ reduction reaction with CO₂. NMR H-spectrum of ¹³C methanol generated during the CO₂ reduction reaction with 13-C labelled CO₂.

FIG. 7 depicts long-term stability performance of Rh/Cu/CrOOH@GalnN photocatalysts, including a) ATR spectrum collected from CO₂/H₂O/Ga(In)N nanowires interface under 420 nm (3 W, LED) light illumination in 60 min using RCC cocatalysts, b) stability tests up to 12 cycles, 720 minutes (each cycle lasted for one hour. After each cycle, the solution was removed and refilled, and the sample was taken out of the reaction chamber and rinsed by deionized water to remove the potentially attached methanol molecules), c) STEM image of RhCuCr₂O₃@GalnN/GaN nanowires sample after 12 cycles reaction. Most particles were removed but the nanowire rod was well preserved.

FIG. 8 depicts the mechanism of CO₂ reduction by H on Cu to produce CH₃OH, including a) schematic representation of proton reduction at the Rh/CrOOH interface and hydrogen spillover from Rh/CrOOH interface to Cu surface, b) free energy profile of CO₂ reduction by surface hydrogen atoms toward CH₃OH at 298.15 K. The relative free energy changes are calculated using CO₂, H₂, and the Cu(111) surface as the zero reference.

FIG. 9 depicts a comparison of two pathways of CO₂ reduction in natural enzymes and Cu surfaces, including (a) proposed binding mode of CO₂ at the active site of the CO dehydrogenase, (b) Crystal structure of CO₂ biding at the Ni, Fe cluster in the CO dehydrogenation (PDB ID: 3b52), (c) optimized structure of CO₂ binding to the negative charge Cu surface, (d) proposed binding mode of CO₂ at the active site of the formate dehydrogenase; (e) Crystal structure of NO₂⁻ biding at the Mo cluster in the formate dehydrogenation (PDB ID: 1dfi); (f) optimized structure of CO₂ binding to surface bound H atom on Cu surface.

The embodiments of the disclosed devices and methods may assume various forms. Specific embodiments are illustrated in the drawing and hereafter described with the understanding that the disclosure is intended to be illustrative. The disclosure is not intended to limit the invention to the specific embodiments described and illustrated herein.

### DETAILED DESCRIPTION OF THE DISCLOSURE

Photocatalytic devices having conductive projections decorated with a co-catalyst arrangement for CO₂ conversion (e.g., reduction) are described. The disclosed devices may include nanowires, nanostructures, or other conductive projections that include one or more III-nitride semiconductors configured for charge carrier generation in response to solar radiation. For instance, each nanowire, nanostructure, or other conductive projection may include multiple segments with differing alloy concentrations to capture multiple bands of solar wavelengths. Each nanowire, nanostructure, or other conductive projection is decorated with a co-catalyst arrangement configured for the CO₂ conversion (e.g., reduction reaction). As described below, the co-catalyst arrangement includes a bi-metallic nanoparticle core (e.g., rhodium and copper) and an oxide shell. The oxide shell may cover only one of the metallic nanoparticles. In some examples, the loading of a bimetallic cocatalyst on a semiconductor photocatalyst results in selective formation of methanol. Methods for fabricating such devices are also described.

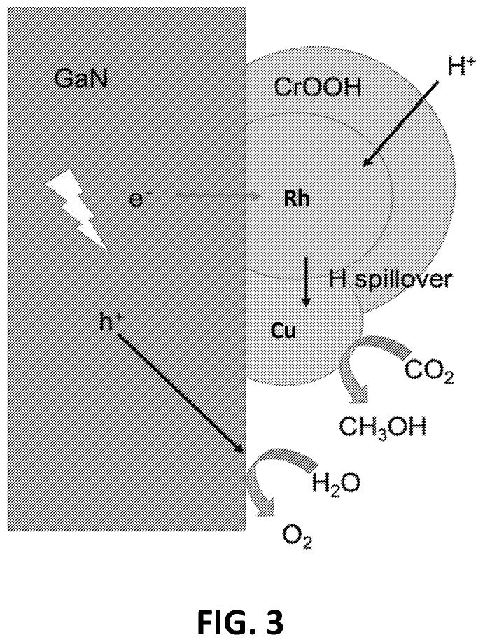

The disclosed devices may provide a wireless architecture for selective CO2 reduction reaction to methanol. In some cases, the photocatalytic system includes InGaN/GaN nanowires loaded with co-catalytic Cu-Rh/CrOx core-shell nanoparticles (as shown in, e.g., FIG. 3), with bimetallic copper-rhodium cores and chromium oxide shells.

Unique to this artificial photosynthetic system is the vectorial transfer of protons, electrons, and hydrogen atoms to Cu active sites, that can switch the mechanism from CO₂ reduction by conventional proton-coupled electron transfer (PCET) via *COOH in aqueous solutions to hydrogenation of CO₂ via HCOO*. High CO₂ reduction activity is shown under visible light irradiation in a mild environment (1 atm CO₂ atmosphere and pH 7 deionized water). In such cases, methanol is the major product, cogenerated with the dioxygen by-product in a 2:3 ratio. One example exhibited an average turnover frequency of 37.8 μmol·cm⁻²·h⁻¹, with the best measured activity being 49.8 μmol·cm⁻²·h⁻¹ (298.5 mmol·g⁻¹·h⁻¹), which corresponds to a record-high solar-to-liquid fuel efficiency of 0.22% and 0.29%, respectively.

The disclosed devices are capable of catalyzing the reduction of CO₂ with water in the absence of applied bias and/or sacrificial agents. For instance, triethanolamine or other sacrificial agents are not required to close the reaction. In this way, operation of the devices may only involve water, CO₂, and sunlight as inputs. As a result, the production of green methanol and/or other chemicals may be realized.

The III-nitride semiconductor-based projections and co-catalyst arrangement present a useful combination of an effective catalyst and a semiconductor platform for the CO2 reduction reaction. The III-nitride semiconductor materials are highly efficient in generating charge carriers from solar radiation.

The disclosed devices and systems may include multi-band (e.g., quadruple-band) structures for artificial photosynthesis and solar fuel conversion with significantly improved performance. For instance, the disclosed devices and systems may include InGaN nanowire arrays to improve the efficiency of the conversion. For example, each nanowire may include layers or segments of different semiconductor compositions, such as In_{0.35}Ga_{0.65}N, In_{0.27}Ga_{0.73}N, In_{0.20}Ga_{0.80}N, and GaN, which present energy bandgaps about 2.1 eV, 2.4 eV, 2.6 eV, and 3.4 eV, respectively. As described herein, such multi-band InGaN and other nanowire arrays are integrated directly on a wafer for enhanced light absorption.

In some cases, the disclosed devices are configured for photochemical methanol synthesis using a bimetallic core/shell dual cocatalyst (e.g., Rh, Cu and Cr₂O₃) in coordination with multi-stacked (or multi-band) InGaN/GaN nanowires. This combination allows methanol to be produced solely from CO₂, H₂O, and solar light. The bi-metallic core and Cr₂O₃ co-catalysts work synergistically.

The configuration of the multi-band nanostructure arrays may vary. In some cases, the arrays include monolithically integrated multiple-band InGaN nanostructures configured to act as photocatalysts. For instance, each nanostructure may include Mg-doped (p-type) In_{0.35}Ga_{0.65}N (Eg of about 2.1 eV), In_{0.27}Ga_{0.73}N (Eg of about 2.4 eV), In_{0.20}Ga_{0.80}N (E_{g} of about 2.6 eV) and GaN (E_{g} of about 3.4 eV) segments. Each nanostructure may thus be capable of absorbing a wide range of the solar spectra, including, for instance, ultraviolet and visible portions of the solar spectra. Additional, fewer, or alternative segments may be included.

Although described in connection with CO₂ reduction into methanol, the disclosed catalytic devices and systems may be used in other chemical reaction contexts and applications. For instance, the disclosed catalytic devices and systems may be useful in connection with CO₂ reduction to various fuels and other chemicals, and activation of C—H bonds for the production of various chemicals. The catalytic devices may also be used in connection with still other reactions not involving CO₂ reduction, such as nitrogen reduction to ammonia.

Although described herein in connection with electrodes having GaN-based nanowire arrays for CO₂ reduction, the disclosed devices are not limited to GaN-based nanowire arrays. A wide variety of other types of nanostructures and other conductive projections may be used. For instance, other III-nitride semiconductors may also be used. Thus, the nature, construction, composition, configuration, characteristics, shape, and other aspects of the conductive projections through which the CO₂ reduction and/or other reaction is catalyzed may vary.

Although described herein in connection with photocatalytic devices and corresponding bias-free and/or wireless systems, one or more aspects of the disclosed devices may be applied in other reaction contexts, including, for instance, electrochemical reactions. Thus, the disclosed devices may be used to catalyze reactions driven by electrical energy either alone or in combination and/or in combination with light.

Although described herein in connection with the reduction of CO₂ to methanol, the disclosed devices may be configured to produce additional or alternative liquid fuels or other products. In such cases, the composition of the co-catalyst arrangements may vary accordingly.

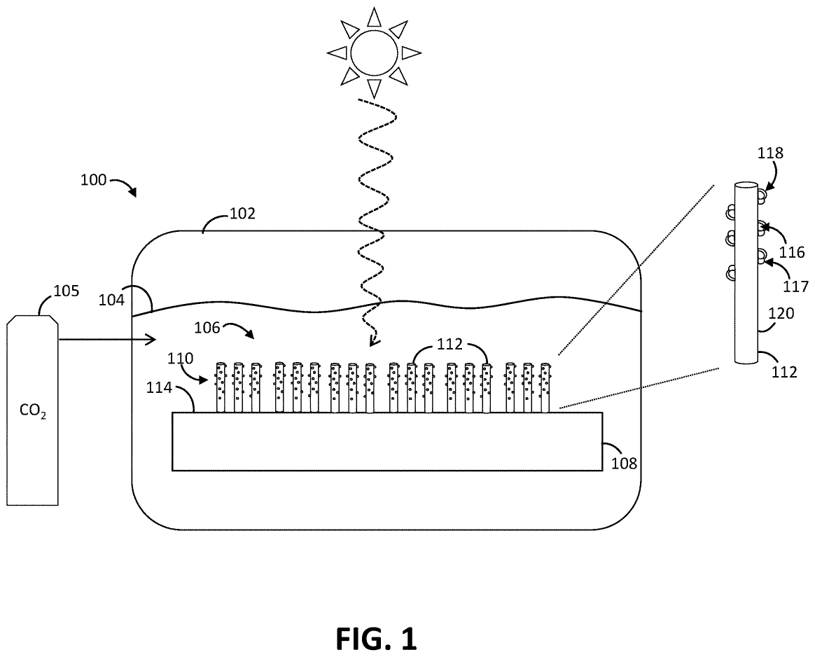

FIG. 1 depicts a photocatalytic system 100 for CO₂ reduction. The CO₂ reduction may include or involve photocatalytic water splitting. Other chemical reactions may also be implemented or supported by the system 100. In this example, the photocatalytic system 100 includes a container 102. In some cases, the container 102 is configured as a sealed reactor, such as a liquid phase reactor. The container 102 may be configured to allow illumination (e.g., solar illumination) of the interior of the container 102. For instance, the container 102 may have a transparent cover, side, cap, or other portion, such as a quartz top. The manner in which the system 100 is illuminated may vary. The size, construction, composition, configuration, and other characteristics of the container 102 may vary. The system 100 may not include a container in other cases.

In the example shown, liquid water 104 is disposed in the container 102. The water 104 may or may not be pure water (e.g., distilled water). The pH of the water 104 may vary accordingly. Some or all of the devices of the system 100 in the container 102 are immersed in the water 104.

The system 100 may include a source 105 of CO₂ coupled to the container 102. The CO₂ source 105 may be integrated to any desired extent with a source of water or water vapor. In some cases, the system 100 receives CO₂ passively and/or without an express source. For example, CO₂ may be supplied in part or whole from the ambient.

As described herein, the system 100 does not include a voltage or other source of electrical energy. Thus, in the example of FIG. 1, the system 100 accordingly implements the CO₂ reduction without the application of a bias voltage to a photocatalytic device of the system 100. In other cases, one or more bias voltages may be applied to one or more electrodes or other components in the system 100.

The system 100 may also be free of sacrificial agents. In the example of FIG. 1, the container 102 is sacrificial agent-free. In other cases, one or more sacrificial agents may be used to promote the CO₂ reduction reaction in the system 100.

The photocatalytic system 100 includes a photocatalytic device 106 disposed in the container 102. The photocatalytic device 106 may be immersed (e.g., partially or completely) in the water 104. In the example of FIG. 1, the photocatalytic device 106 is disposed in the container 102 in a manner to allow the incident light to illuminate the semiconductor device 106. In some cases, the photocatalytic device 106 is configured for CO₂ reduction with water splitting in response to the illumination.

The semiconductor device 106 includes a substrate 108 and an array 110 of conductive projections 112 supported by the substrate 108. In some cases, each conductive projection 112 is or includes a nanowire or other nanostructure. In this example, each conductive structure 112 is or includes a cylindrically shaped nanostructure. The cylindrical shape has a circular cross-sectional shape (e.g., a circular cylinder), as opposed to, for instance, a plate-shaped or sheet-shaped nanostructure. The conductive projections 112 may thus be configured, and/or referred to herein, as nanowires. In this example, the nanowires 112 extend outward from a top or upper surface 114 of the substrate 108. Alternative or additional surfaces of the substrate 108 may support the array 110.

The substrate 108 may be active (e.g., functional) and/or passive (e.g., structural). In one example of the former case, the substrate 108 may be or include a reflective material or layer to direct light back toward the nanowires 112. In one example of the latter case, the substrate 108 may be configured and act solely as a support structure for the nanowires 112. Alternatively or additionally, the substrate 108 may be composed of, or otherwise include, a material suitable for the growth or other deposition of the nanowires 112.

The substrate 108 may include a light absorbing material. In such cases, the light absorbing material is configured to generate charge carriers upon solar or other illumination. The light absorbing material has a bandgap such that incident light generates charge carriers (electron-hole pairs) within the substrate. Some or all of the substrate 108 may be configured for photogeneration of electron-hole pairs.

The substrate 108 may include a semiconductor material. In some cases, the substrate 108 is composed of, or otherwise includes, silicon. For instance, the substrate 108 may be provided as a silicon wafer. The silicon may or may not be doped. The doping arrangement may vary. For example, one or more components of the substrate 108 may be non-doped (intrinsic), or effectively non-doped. The substrate 108 may include alternative or additional layers, including, for instance, support or other structural layers. The composition of the substrate 108 may thus vary. For example, the substrate may be composed of, or otherwise include, metal films, GaAs, GaN, or SiOₓ in other cases.

The substrate 108 may establish a surface, e.g., the surface 114, at which a catalyst arrangement (e.g., a photocatalyst arrangement) of the semiconductor device 106 is provided. The photocatalyst arrangement is provided by the nanowires 112 of the array 110. In some cases, the catalyst arrangement may be or include a co-catalyst arrangement including a core-shell architecture, as described herein.

Each nanowire 112 may have a semiconductor composition for charge carrier generation in response to solar radiation. In some cases, the semiconductor composition includes one or more III-nitride semiconductor materials, such as gallium nitride (GaN) and/or one or more alloys of indium gallium nitride (InGaN). Further details regarding examples having stacks of GaN/InGaN segments are provided below. Additional or alternative semiconductor materials may be used, including, for instance, indium nitride, indium gallium nitride, aluminum nitride, boron nitride, aluminum oxide, and silicon, gallium phosphide, gallium arsenide, indium phosphide, tantalum nitride, silicon, and other semiconductor materials. Alternative or additional materials may be used, including, for instance, perovskite materials.

Each nanowire 112 may be or include a columnar, rod-shaped, post-shaped, or other elongated structure. The nanowires 112 may be grown or formed as described in U.S. Pat. No. 8,563,395 (“Method of growing uniform semiconductor nanowires without foreign metal catalyst and devices thereof”), the entire disclosure of which is hereby incorporated by reference. The dimensions (e.g., length, diameter), size, shape, and other characteristics of the nanowires 112 may vary.

The semiconductor composition of each nanowire 112 allows charge carriers to be generated to support the CO₂ reduction reaction and water splitting (i.e., water oxidation reaction of 2H₂O−>O₂+4H⁺+4e⁻) . Proton diffusion from the water oxidation reaction to the CO₂ reduction reaction may occur across a single one of the nanowires 112. Alternatively or additionally, the proton diffusion may occur between two adjacent nanowires 112 in the array 110. The protons may diffuse through liquid water present between the nanowires 112 and/or through the water 104 or other liquid in which the device 100 is immersed.

Each nanowire 112 extends outward from the surface 114 of the substrate 108. In this example, the surface 114 of the substrate 108 is planar. Alternatively or additionally, the surface 114 of the substrate is nonplanar. In such cases, one or more subsets of the array 110 may be oriented at different angles. Examples of nonplanar substrates include various types of multi-faceted surfaces, such as a pyramidal textured surface. For instance, the pyramids of the surface 114 are square-based pyramids with four sides defined by the <111>crystallographic planes. Further details regarding examples of such nonplanar substrates and corresponding dopant gradients are provided in International Publication No. WO 2021/195484 (“Doping Gradient-Based Photocatalysis,” the entire disclosure of which is hereby incorporated by reference. The manner in, or degree to, which the surface 114 is multi-faceted or otherwise nonplanar may vary. For instance, the surface 114 may have any number of faces oriented at any angle. The pyramids or other shapes along the surface 114 may be uniform or non-uniform.

The nanowires 112 may be configured to generate electron-hole pairs upon illumination. The nanowires 112 may be configured to generate the electron-hole pairs upon absorption of light at certain wavelengths (e.g., solar wavelengths). In some cases, each nanowire 112 may have multiple segments, with each segment being configured to absorb light over a respective range of wavelengths and, thus, improve the efficiency of the photocatalytic water splitting. For instance, each nanowire 112 may include a stacked or layered arrangement of semiconductor materials. Each layer in the arrangement may be configured for absorption of light of solar wavelengths (e.g., infrared, visible, and/or ultraviolet wavelengths).

The layered arrangement of semiconductor materials is used to establish a multi-band structure, such as a quadruple band structure. Each layer or segment of the arrangement may have a different semiconductor composition to establish a different bandgap. For instance, in III-nitride examples, the layers or segments of the arrangement may have different indium and gallium compositions. Examples of layered arrangements configured to provide a multi-band structure are shown and described below.

The layered arrangement of the nanowires 112 may vary from the examples described herein. For example, further details regarding the formation and configuration of multi-band structures, including, for instance, triple-band structures, are provided in U.S. Pat. No. 9,112,085 (“High efficiency broadband semiconductor nanowire devices”) and U.S. Pat. No. 9,240,516 (“High efficiency broadband semiconductor nanowire devices”), the entire disclosures of which are incorporated by reference.

The semiconductor composition of each nanowire 112 may be configured to improve the efficiency of the water splitting and CO₂ reduction reaction in additional ways. For instance, in some cases, the semiconductor composition of each nanowire 112 may include doping to promote charge carrier separation and extraction, as well as to facilitate the establishment of a photochemical diode (e.g., to promote charge carrier separation and extraction). For example, a dopant concentration of the semiconductor composition may vary laterally and/or from layer to layer.

In examples involving III-nitride compositions, the dopant may be or include magnesium. Further details regarding the manner in which magnesium doping promotes charge carrier separation and extraction are set forth in U.S. Pat. No. 10,576,447 (“Methods and systems relating to photochemical water splitting ”), the entire disclosure of which is incorporated by reference. Additional or alternative dopant materials may be used, including, for instance, silicon, carbon, zinc, and beryllium, depending on the semiconductor light absorber of choice.

The photocatalytic device 106 further includes a co-catalyst arrangement supported by the array 110 of nanowires 112. As shown in FIG. 1, each nanowire is decorated with a co-catalyst arrangement. The co-catalyst arrangement may be or include a bi-metallic nanoparticle arrangement. The co-catalyst arrangement may thus have or include a bi-metallic composition, including a first metallic nanoparticle 116 and a second metallic nanoparticle 117. In some cases, the first and second metallic nanoparticles are composed of, or otherwise include, Rh and Cu, respectively. The bi-metallic nanoparticle arrangement are distributed or disposed over the array 110 of nanowires 112. Pluralities of the bi-metallic nanoparticle arrangements are disposed on each nanowire 112, as schematically shown in FIG. 1. The bi-metallic nanoparticle arrangements are distributed across or along the outer surface(s) of each nanowire 112. In the example of FIG. 1, the bi-metallic nanoparticle arrangements are disposed along sidewalls 120 of the nanowires 112. Alternatively or additionally, the bi-metallic nanoparticle arrangements are disposed along one or more other surfaces of the nanowires 112, such as a top or upper surface.

The co-catalyst arrangement may be disposed in, or otherwise include, a core-shell configuration. As shown in FIG. 1, each first metallic nanoparticle 116 is covered or surrounded by an oxide shell 118. Each first metallic nanoparticle 116 is thus provided or configured as a metal (e.g., Rh) core of the core-shell configuration. For instance, each first metallic nanoparticle 116 may be configured as, or otherwise include, a nanoparticle composed of, or otherwise including, Rh. Each oxide shell 118 is provided or configured as a shell of the core-shell configuration. Each oxide shell 118 is composed of, or otherwise includes, an oxide material, such as chromium oxide.

Each first metallic nanoparticle 116 is covered by the oxide shell 118 in the sense that the nanoparticle 116 is not exposed to the surrounding medium (e.g., water). Each first metallic nanoparticle 116 thus may or may not be completely enclosed, encompassed, or covered by the shell of the oxide shell 118. For instance, the first metallic nanoparticle 116 may be disposed between the oxide shell 118 and an outer surface of the nanowire 112. As used herein, the term “cover” and its derivatives are used to distinguish surfaces that are effectively not exposed from those that are effectively exposed.

As shown in the examples of FIG. 1 and FIG. 3, the oxide shell 118 does not cover the outer surface of each second metallic nanoparticle 117. The lack of coverage may arise from the difference in composition of the first and second metallic nanoparticles. For instance, each first metallic nanoparticle is composed of, or otherwise includes, a first metal (e.g., Rh). Each second metallic nanoparticle is composed of, or otherwise includes, a second metal (e.g., Cu). In some cases, the second metal has a larger lattice mismatch with the oxide material of the oxide shell 118 than the first metal. As a result, during fabrication, the oxide shell 118 may be formed only or otherwise preferentially on the first metal.

As described further below, each first metallic nanoparticle 116 is configured to reduce protons in the aqueous solution to hydrogen atoms. Each pairing of first metallic nanoparticle 116 and second metallic nanoparticle 117 may then be arranged such that the hydrogen atoms diffuse from the first metallic nanoparticle 116 to the second metallic nanoparticle 117 to hydrogenate the carbon dioxide (CO₂) present at the outer surface of the second metallic nanoparticle 117. The co-catalyst arrangement is thus configured to facilitate or promote the conversion of carbon dioxide (CO₂) via hydrogenation in aqueous solution. Further details regarding the formation, configuration, functionality, and other characteristics of the co-catalyst arrangement in conjunction with a nanowire array are set forth herein and/or in one or more of the above-referenced U.S. patents.

In some cases, each oxide shell 118 is composed of, or otherwise include, chromium oxide (CR₂O₃). However, additional or alternative oxide materials may be used, including, for instance, iridium oxide, copper oxide, and nickel oxide.

In some cases, the metallic nanoparticles 116, 117 are composed of, or otherwise include, metals other than Rh and Cu. For instance, additional or alternative metallic materials may be used, including, for instance, gold, platinum, nickel, palladium, iron, and copper, as well as alloys thereof.

The distribution of the co-catalysts may be uniform or non-uniform. For instance, the co-catalysts may thus be distributed uniformly in the sense that each nanowire 112 is decorated with the co-catalysts. The specific location of the co-catalysts on each nanowire 112 may be differ from nanowire to nanowire. The schematic arrangement of FIG. 1 is shown for ease in illustration.

The nanowires 112 and the co-catalysts are not shown to scale in the schematic depiction of FIG. 1. The shape of the nanowires 112 and the co-catalysts may also vary from the example shown. Further details regarding examples of the nanowires and co-catalyst arrangement, including the fabrication thereof, are provided below.

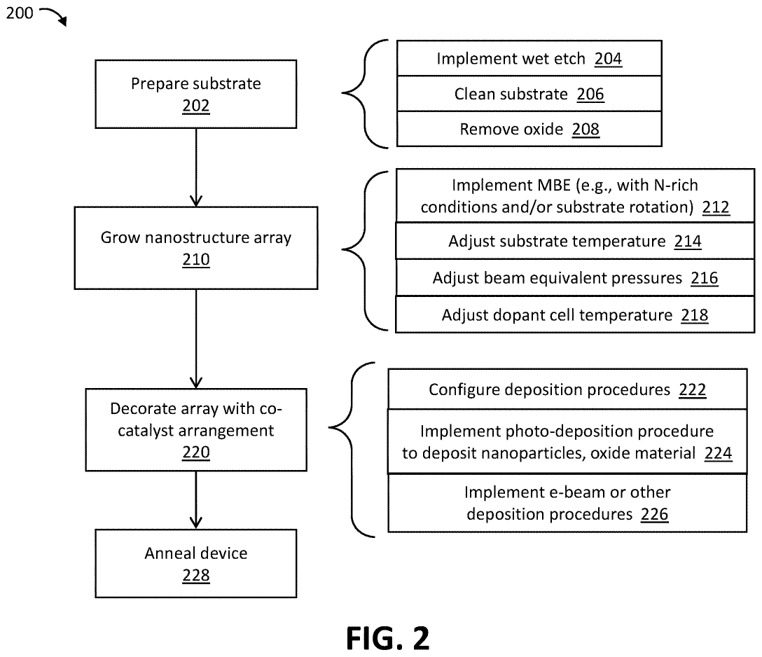

The nanowire and co-catalyst arrangement may be fabricated on a substrate (e.g., a silicon substrate) via nanostructure engineering. In one example, molecular beam epitaxial (MBE) growth of the nanowires is followed by photo-and/or other deposition of the catalysts. Further details regarding example fabrication procedures are provided below, e.g., in connection with FIG. 2.

The nanowires 112 may facilitate the water splitting in alternative or additional ways. For instance, each nanowire 112 may be configured to extract charge carriers (e.g., electrons) generated in the substrate 108 (e.g., as a result of light absorbed by the substrate 108). In such cases, the opposite side of the substrate 108 may be configured for hole extraction. The extraction brings the charge carriers to external sites along the nanowires 112 for use in the reduction of CO₂ and/or other reactions.

FIG. 2 depicts a method 200 of fabricating a photocatalytic device for CO₂ reduction in accordance with one example. The method 200 may be used to manufacture any of the devices described herein or another device. The method 200 may include additional, fewer, or alternative acts. For instance, the method 200 may or may not include one or more acts directed to annealing the device (act 228).

The method 200 may begin with an act 202 in which a substrate is prepared or otherwise provided. The substrate may be or be formed from a silicon wafer. In one example, a 2-inch Si wafer was used, but other (e.g., larger) size wafers may be used. Other semiconductors and substrates may be used.

In some cases, the act 202 includes an act 204 in which a wet or other etch procedure is implemented to define the surface (e.g., nonplanar surface). For example, the etch procedure may be or include a crystallographic etch procedure. In silicon substrate examples, the crystallographic etch procedure may be or otherwise include a KOH etch procedure. In such cases, if the substrate has a <100>orientation, the wet etch procedure establishes that the surface includes a pyramidal textured surface with faces oriented along <111>planes, but additional or alternative facets may be present in some cases.

The act 202 may include fewer, additional, or alternative acts. For instance, in the example of FIG. 1, the act 202 includes an act 206 in which the substrate is cleaned, and an act 208 in which oxide is removed.

In one example, a prime-grade polished silicon wafer is etched in 80 °C KOH solution (e.g., 1.8% KOH in weight with 20% isopropanol in volume) for 30 minutes to form the micro-textured surface with Si pyramids. After being neutralized in concentrated hydrochloric acid, the substrate surface is cleaned by acetone and/or methanol, and native oxide is removed by 10% hydrofluoric acid.

The method 200 includes an act 210 in which a nanowire or other nanostructure array is grown or otherwise formed on the substrate. Each nanowire is formed on the surface of the substrate such that each nanowire extends outward from the surface of the substrate. Each nanowire has a semiconductor composition, as described herein. The nanowire growth may be achieved in an act 212 in which a molecular beam epitaxy (MBE) procedure is implemented. The MBE procedure may be implemented under nitrogen-rich conditions. Alternatively or additionally, the substrate may be rotated during the MBE procedure such that each nanostructure is shaped as a cylindrically shaped nanostructure. Each nanowire may thus have a circular cross-sectional shape, as opposed to a plate-shaped or sheet-shaped nanostructure.

In some cases, the MBE procedure may be modified to fabricate an arrangement of layers or segments of each nanowire directed to providing a multi-band structure. Various parameters may be adjusted to achieve the different composition levels of the layers. For instance, the substrate temperature may be adjusted in an act 214. Beam equivalent pressures may be adjusted in an act 216. In some cases, a dopant cell temperature is adjusted to control the doping (e.g., Mg doping) of the nanowires.

In one example, Mg-doped InGaN nanowires were grown by plasma-assisted molecular beam epitaxy (MBE) under N-rich conditions. The growth parameters included a gallium (Ga) beam equivalent pressure of about 7E-8 Torr, a nitrogen flow rate of 1 sccm, and a plasma power of 350 W. The substrate temperature, indium (In) beam equivalent pressure (BEP), and magnesium (Mg) cell temperature were tuned to synthesize different single-band or multi-band InGaN nanowires with various p-doping and alloy concentrations. For instance, for single-band p-GaN nanowires or a GaN layer of a multi-band structure, the substrate temperature was 685 °C, and Ga BEP was about 7E-8 Torr. The p-type doping level was tuned by using different Mg cell temperatures. For a p-In_{0.20}Ga_{0.80}N nanowire layer, the substrate temperature was 675 °C, the Ga BEP was about 7E-8 Torr, and the In BEP was about 7.3E-8. For p-In_{0.27}Ga_{0.73}N nanowire layers, the substrate temperature was 662 °C, the Ga BEP was about 7E-8 Torr, and the In BEP was about 7.3E-8. For p-In_{0.35}Ga_{0.65}N nanowire layers, the substrate temperature was 640 °C, the Ga BEP was about 7E-8 Torr, and the In BEP was about 3.5E-8. For quadruple-band InGaN nanowires, the growth conditions are similar to those of the constituting single-band nanowires but with varying thicknesses for each segment. The substrate temperature may refer to a thermocouple reading of a substrate heater, which may be different from the actual substrate surface temperature, which may depend on the sample size, substrate holder, and mounting configuration.

The act 210 may include additional, fewer, or alternative acts. For instance, the act 210 may include one or more acts directed to forming a seed other initial layer in preparation for growth of the nanowires. The seed layer may be configured to promote the nucleation of the nanowires. In some cases, the seed layer is composed of, or otherwise includes, Ga. Further details regarding the use of seed layers are set forth below in connection with a number of examples as well as in the above-referenced patent documents.

As shown in FIG. 2, the method 200 further includes an act 220 in which the array is decorated with a co-catalyst arrangement. The co-catalysts are deposited across the array of nanowires. As described herein, the dual catalysts may be disposed in, or include, a core-shell configuration.

The deposition of the nanoparticles may be achieved via implementation of one or more deposition procedures. In the example of FIG. 2, the act 220 includes an act 222 in which one or more of the deposition procedures is configured. The configuration may be directed to establishing a ratio of the catalysts. Further details are provided below in connection with a number of examples.

In the example of FIG. 2, the act 220 include an act 224 in which the co-catalyst arrangements are deposited on the nanowires. In some cases, the deposition of the co-catalyst arrangements includes implementation of a photo-deposition procedure in an act 226. Additional or alternative procedures may be used, including, for instance, e-beam evaporation and/or other physical vapor deposition procedures, such as sputtering, as well as atomic layer deposition procedures. Further details regarding examples of the photo-deposition procedure are set forth hereinbelow and in one or more of the above-referenced U.S. patents.

In one example, a photo-deposition process is performed in a sealed Pyrex chamber with a quartz lid. After placement of the device in the chamber, 60 mL deionized water (purged with Ar for 20 mins before use), is added. To deposit the oxide shell, HAuCl₄ (≥99.0%, Sigma Aldrich), K₂CrO₄ (≥99.0%, Sigma Aldrich), and 15 mL methanol (99.8%, ACP Chemicals) are added in sequence. The chamber is evacuated and irradiated for 30 min for photo-deposition of the Cr₂O₃.

The method 200 may include one or more additional acts directed to forming the photocatalytic structures of the device. For instance, in some cases, the method 200 includes an act 228 in which the photocatalytic structures of the device are annealed. The parameters of the anneal process may vary.

The order of the above-described acts of the method 200 may differ from the example shown. For instance, the annealing of the act 228 may be implemented before or after the deposition of the nanoparticles in the act 220.

Details regarding examples of the above-described devices and fabrication methods are now provided in connection with FIGS. 3-9.

FIG. 3 depicts an example in which InGaN/GaN nanowires function as visible-light absorbers by separating charge carriers generated via incident radiation. The photogenerated electrons flow into the Cu—Rh/CrOx nanoparticles where protons are reduced and bind to the Rh surface as hydrogen atom adsorbates. Rh/CrOₓ core-shell nanoparticles are efficient catalysts for H₂ evolution by H₂O reduction. On the Cu—Rh/CrOₓ nanoparticles, the in situ generated hydrogen atoms spillover to the nearby Cu sites and react with CO₂. The CO₂ is hydrogenated leading to the selective production of CH₃OH, in contrast to electrocatalytic CO₂ reduction on Cu surfaces that typically yield a mixture of products.

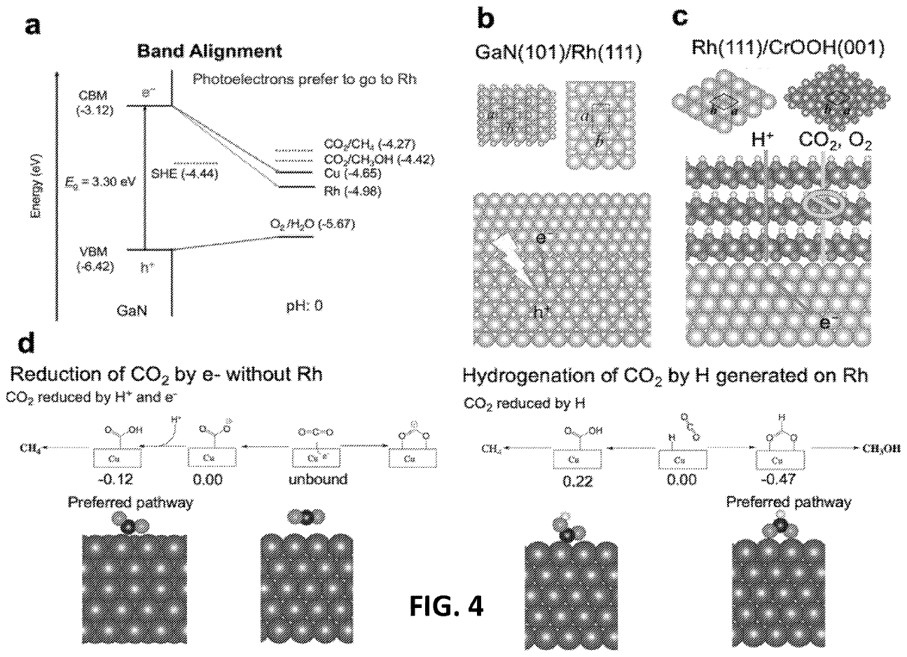

With reference to FIG. 4, to explore the reaction mechanism, interfacial structures of GaN/Rh, GaN/Cu, Rh/Cu, Rh/CrOOH, and Cu/CrOOH were synthesized. The other structures were explored considering that electrons transfer from Cu to Rh since the work function of Rh is larger than that of Cu. It was found that the Rh(111) facet matches the GaN(1010) facet very well, with a lattice mismatch less than 4% (FIG. 4, part b). The interaction between Cu and GaN, however, is not as favorable due to the larger lattice mismatch between the Cu(111) and GaN(1010) surfaces, yielding a weaker interaction and a large kinetic barrier for electron transfer from GaN to Cu. So, the electron transfer pathway from GaN to Rh determines the main electron transfer pathway because it is favored by both thermodynamics and kinetics.

Density functional theory (DFT) analysis of Rh/CrOOH and Cu/CrOOH interfaces (FIG. 4, part c) shows that Rh is likely covered by a CrOOH shell. Furthermore, the CrOOH shell is unlikely to form on Cu due to the lattice mismatch, which prevents growth of CrOOH on Cu(111). The Rh/Cr and Rh/Cu interfaces allow for unidirectional proton transfer and reduction, followed by hydrogen spillover from Rh to Cu. The exposed Cu surface enables hydrogenation of CO₂ by hydrogen adsorbates effectively inducing catalytic CO₂ reduction. Therefore, the DFT computational analysis supports the viability of the catalytic architecture shown in, e.g., FIG. 3.

Analysis of CO₂ reduction on Cu(111) established that CO₂ reduction can occur via two reaction pathways, including standard electrochemical reduction by proton-coupled electron transfer (PCET) using electrons from the electrode and protons from the bulk solution, and hydrogenation by surface adsorbed H atoms (reducing equivalents of H⁺+e⁻). The reduction of CO₂ with electrons was modeled by preparing a negatively charged Cu surface, which serves as a model of the electrified Cu electrode. The binding of CO₂ on the charged Cu surface was then analyzed. It was found that binding of CO₂ through the oxygen atoms is unfavorable, resulting in physisorption of CO₂ with distances of about 3 Å from Cu to O in the CO₂ molecule (FIG. 4, part d). However, binding of CO₂ through C forms a *COO⁻ species, which can be readily protonated by protons from the bulk solution to form the *COOH intermediate, leading to formation of *CO and ultimately hydrocarbon products such as CH₄, C₂H₄, etc. In fact, that is the favored mechanism for most electrochemical CO₂ reductions on Cu electrodes, which exhibits poor selectivity. In contrast, when CO₂ is reduced by H atoms on the Cu surface, both the *COOH and HCOO* binding modes of CO₂ are possible, with the HCOO* binding mode being more favorable. (FIG. 4, part d).

Therefore, the photochemical architecture (e.g., shown in FIG. 3) with vectorial transfer of protons, electrons, and hydrogen atoms to the Cu active site can achieve high selectivity of CO₂ photoreduction to CH₃OH. As described below, such a catalytic architecture can be experimentally realized on InGaN nanowires.

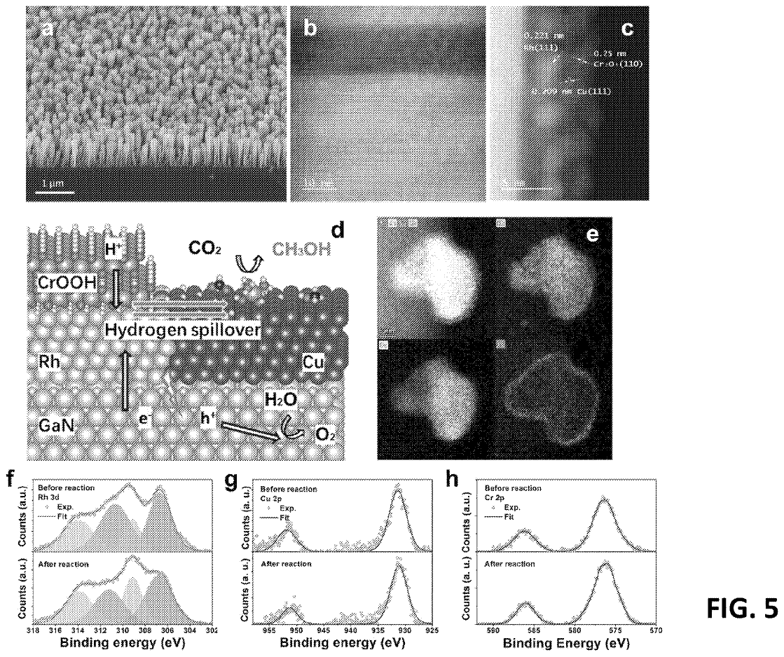

FIG. 5 depicts the synthesis and characterization of photocatalysts in connection with one example. Single crystalline Mg-doped p-type InGaN/GaN nanowire arrays were grown on a silicon wafer utilizing molecular beam epitaxy. The ratio of indium and gallium of InGaN was determined by X-ray diffraction. The band gap of the InGaN/GaN nanowires was located at about 525 nm. Co-catalysts Rh, Cu and Cr₂O₃ were then photo-deposited on the nanowire surface. FIG. 5, part a, shows InGaN/GaN nanowires grown on the silicon wafer with an average length of about 1 um and width of about 100 nm. FIG. 5, part b, shows the high angle annular dark field-scanning transmission electron microscopy (HAADF-STEM) image of an InGaN/GaN nanowire after photo-deposition of the co-catalysts. The grey spots show that the co-catalytic nanoparticles decorated the sidewalls of the InGaN/GaN nanowire well. FIG. 5, part e, shows the energy dispersive X-ray (EDS) elemental mapping of the material, showing 10 nm particles with a distinct Rh and Cu core and Cr₂O₃ shell. Note here that EDS mapping merely exhibits a two-dimensional perspective, while the signals lay on the images with a three-dimensional depth. Likewise, FIG. 5, part c, shows the deposited core-shell particles of Rh, Cu and CrOOH (Cr₂O₃·H₂O) widely dispersed on the nanowire surface, also shown in FIG. 5, part b. Typically, the CrOOH shell shared or had a thickness of around 2 nm for most of the observed particles, corresponding to 3-4 layers of CrOOH. The core could vary from 2 to 20 nm due to randomness in the photo-deposition. As predicted by the DFT calculations (FIG. 5, part d), Cr₂O₃·H₂O self-assembles during the reaction in-situ and forms a film of CrOOH on the Rh surface.

The average loaded amount of Rh, Cu and Cr is 0.067 μmol/cm², 0.21 μmol/cm² and 0.0062 μmol/cm², respectively, estimated through inductively coupled plasma-atomic emission spectroscopy (ICP-AES). The chemical states of each photo-deposited cocatalyst were analyzed by X-ray photoelectron spectroscopy (XPS) before and after the photocatalytic reaction. The Rh 3d_{5/2} spectrum exhibits four peaks which correspond to the metallic and the oxidized state of Rh (FIG. 5, part f) indicating a strong interaction between Rh and CrOx. It is further noticed that the ratio of intensities between the oxide and metal peaks increases after the photocatalytic reaction. FIG. 5, part g, shows the Cu 2p_{3/2} XPS spectra taken before and after the photocatalysis reaction. Together with the location of copper LMM peak at 918.69 eV (Kinetic energy), these results show no chemical shift relative to metallic copper, suggesting a negligible amount of Cu₂O. Therefore, there is no significant interaction, or synergetic effect between chromium oxide and copper likely due to the lattice mismatch and weaker interactions between Cu and CrOOH. It is further noticed that both copper and chromium show no chemical shift before and after the reaction (FIG. 5, parts g, h). The XPS spectrum is thus consistent with the foregoing DFT calculations (FIG. 5, part d), showing that Rh atoms on the surface are directly interacting with both Cu atoms and CrOOH layers, while Cu atoms have no significant interaction with CrOOH. The Cu surface is thus exposed to the solution favoring adsorption of CO₂.

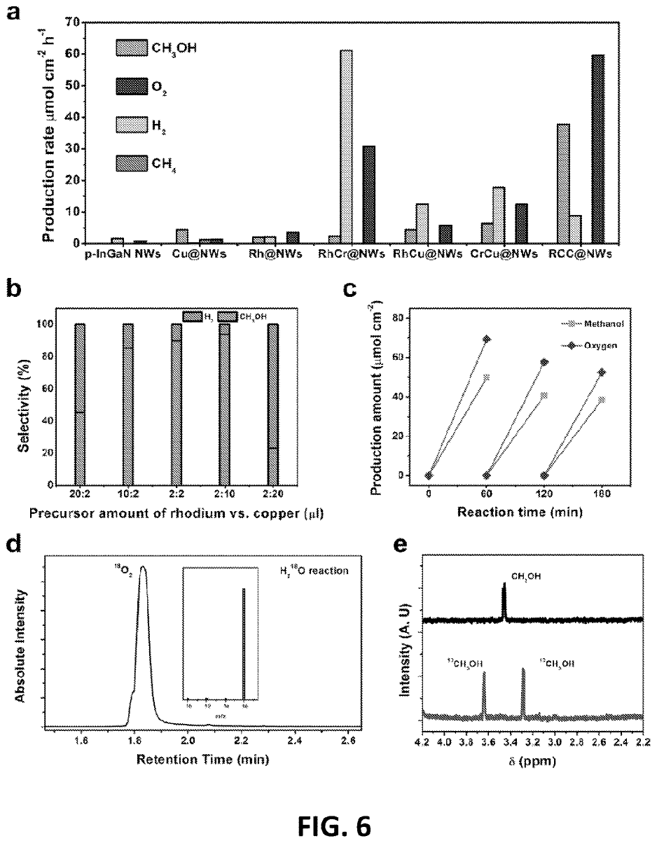

The results of photocatalytic reaction operation of the example and other arrangements are now provided. The photocatalytic performance of RhCuCr₂O₃/InGaN was characterized using a solar simulator, with water and CO₂ as the feedstocks. Therefore, sunlight was the only energy input to this wireless photocatalytic reaction. FIG. 6, part a, shows the rate of generation of CH₃OH, H₂, CH₄, and O₂ using InGaN with (or without) the incorporation of Cu and Rh/CrOOH co-catalysts, averaged over three cycles. The InGaN nanowires exhibit a negligible photocatalytic activity. Incorporation of Rh/CrOOH enhances the photocatalytic activity, yielding H₂ and O₂ as the major products due to water splitting, as well as trace amounts of CH₃OH. Incorporation of Cu on the InGaN nanowire arrays generates a small amount of CH₃OH and trace amounts of CH₄ and O₂. InGaN nanowires with both Cu and Rh/CrOOH exhibit a dramatic enhancement in the production rate and selectivity for CH₃OH. Generation of CH₃OH and O₂ maintains a stoichiometric ratio of 2:3 only when loading both Cu and Rh/CrOOH.

The analysis of the photocatalytic performance of InGaN nanowire arrays with either Rh/Cu or Cu/CrOOH provided further insights on the reaction mechanisms and confirmed the superior performance of the Rh/Cu/CrOOH arrangement on InGaN nanowires. FIG. 6, part a, shows the performance of Rh/Cu and Cr/Cu deposited on InGaN nanowires. Significant loss of catalytic activity is observed for InGaN nanowires with only Rh/Cu without CrOOH, or only Cu/CrOOH without Rh. Those results show that the highest turnover frequency and selectivity of methanol generation is obtained when Rh, Cu, and CrOOH are simultaneously incorporated into the InGaN nanowires. The simultaneous incorporation of Rh, Cu and CrOOH also leads to high turnover numbers with stable production of methanol over many cycles.

One observation is that the CrOOH does not function as a protective shell to preserve the methanol production efficiency in the case of Cu/CrOOH, even though it significantly enhances the overall water splitting performance in the case of Rh/CrOOH.

These differences are likely due to the lattice mismatch between CrOOH (2.98 Å) and copper (2.56 Å), which prevents formation of the Cu/CrOOH core-shell structures observed for Rh with CrOOH. In fact, significant differences in composition of the surface were confirmed by STEM characterization and the EDS signals spectrum of Cu/CrOOH of co-deposited samples. The data thus provides unambiguous evidence for a synergistic effect of Rh, Cu, and CrOOH in promoting CO₂ reduction to methanol. Significantly, the production of methanol and oxygen remains nearly stoichiometric when using the Rh/Cu/CrOOH arrangement on InGaN nanowires. The activity of methanol and oxygen production remains nearly constant during three cycles of measurements (FIG. 6, part c), showing negligible decomposition or poisoning of the photocatalyst, commonly reported for other systems developed for photo-driven CO₂ reduction.

The effect of different loading amounts of Cu and Rh on the photocatalytic performance for reduction of CO₂ to CH₃OH was also studied. FIG. 3, part b, shows that a relatively low rate of CH₃OH and low selectivity are observed when either Rh, or Cu dominates, presumably due to the lack of proper formation of Rh/CrOOH/Cu core-shell structures under those extreme deposition conditions. In addition, a high production rate (49.7 μmol·cm⁻²·h⁻¹) and high selectivity (greater than 80%) were observed for a wide range of Rh/Cu precursor ratios (e.g., from 10:2 to 2:10), consistent with formation of robust Rh/CrOOH/Cu core-shell structures as confirmed by STEM characterization.

Further analysis of products source tracing and GC/NMR measurements utilizing ¹³CO₂ and H₂¹⁸O as feedstocks confirms that the carbon in the product CH₃OH originated from carbon dioxide. Furthermore, the analysis of the gas products from gas chromatography-mass spectrometry (GC-MS) (FIG. 6, part d) shows a clear m/z equal to 36 peak due to ¹⁸O₂, confirming that the by-product dioxygen was generated from water, consistent with the reaction mechanism predicted by the DFT calculations. Furthermore, the analysis of the liquid products by nuclear magnetic resonance (NMR) (FIG. 6, part e) shows a clear split peak due to the extra neutron in the ¹³C atom, supporting that ¹³CO₂ is the carbon source for the methanol product.

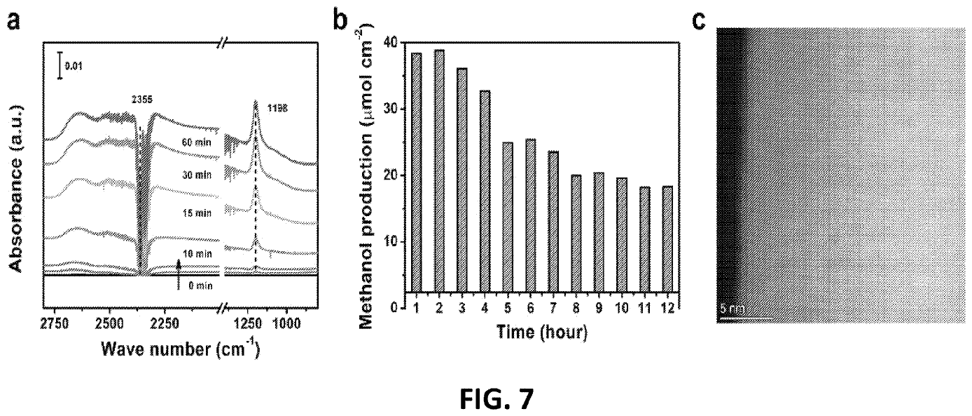

The change of attenuated total reflectance (ATR) signals at CO₂/H₂O/RCC-InGaN interface reveals the gain or loss of species. As shown in FIG. 7, part a, during 60 min irradiation, the IR negative peak at 2355 cm⁻¹, attributed to the antisymmetric stretching vibration of O═C═O in CO₂, sharply decreased with irradiation time due to CO₂ reduction.

Meanwhile, an increasing IR peak at 1198 cm⁻², attributed to the stretching vibration of C—O bond in C—O—H, was also observed, which is close to the reported C—OH stretching band on Cu, further demonstrating the reduction of CO₂.

Long-term stability studies of the Rh/Cu/CrOOH arrangement on InGaN nanowires were also performed. The measurements for the stability test were performed on separately prepared samples for a total of twelve cycles (FIG. 7, part b). The results show a decrease in performance along the evolution of multi-cycles, although the productivity remained at a fairly high level greater than 15 μmol·cm⁻²·h⁻¹. The activity loss is not due to degradation of the InGaN/GaN nanowire light absorber, but rather related to mechanical loss of coated metal particles during rinsing, as confirmed by a detailed STEM characterization of the nanowire after the reaction (FIG. 7, part c). Between each cycle of the reaction, the sample was rinsed with deionized water to remove traces of methanol that might otherwise affect the analysis of performance. The rinsing process, however, unavoidably removed some number of co-catalysts and nanowires from the surface. The mechanical stability of the catalyst may be enhanced by coating the surface of the co-catalyst nanoparticles with a thin layer of Al₂O³ or TiO₂.

The reaction mechanisms were also further studied. A computational analysis of CO₂ reduction on the Cu(111) surface was performed at the DFT level. The work functions of Cu and Rh and the favorable contact between Rh(111) and GaN(101̅0) surfaces, favors a mechanism where photoelectrons transfer to the Rh nanoparticles and reduce protons on the Rh surface to form surface bound hydrogen atoms. Once the hydrogen atom adsorbates saturate the coverage of the Rh(111) surface, they diffuse to nearby Cu surface sites since the diffusion barriers for hydrogen atoms on transition metal surfaces are small (about 0.1 eV).

The calculated adsorption energies of hydrogen on bare Rh(111) and Cu(111) surfaces (i.e., at a low coverage of θ equal to 1/12) are −0.64 and −0.34 eV, respectively.

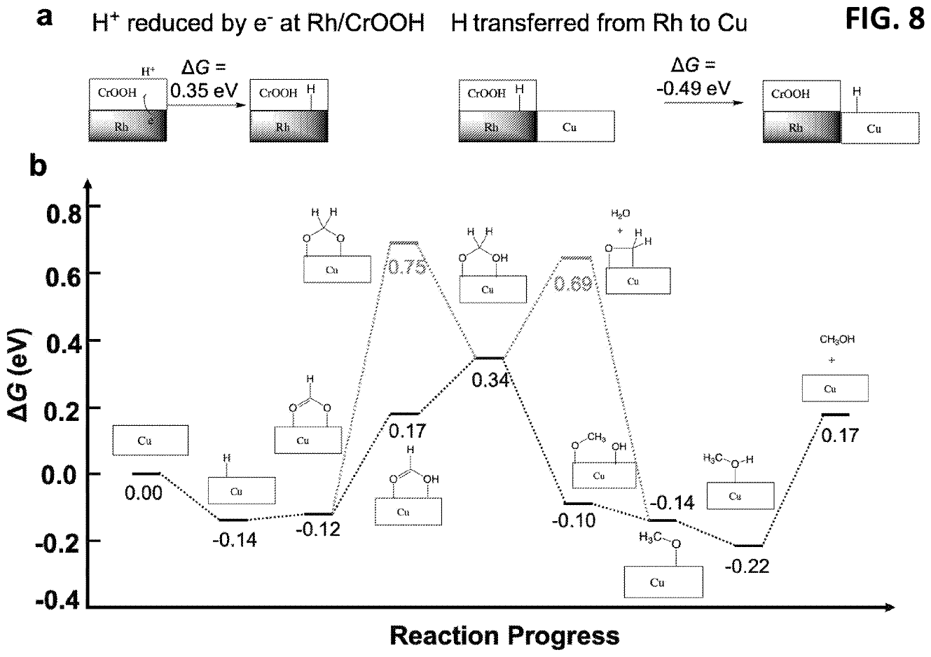

The obtained binding energy on Rh(111) is in fairly good agreement with the experimental value (−0.80 eV) for low coverage of hydrogen on Rh(111), while the calculated adsorption energy on Cu(111) is consistent with previously reported computational results of −0.3 to −0.4 eV on Cu(111). Clearly, hydrogen adsorbs more strongly on bare Rh(111) than on Cu(111). However, in the example photocatalytic system, the Rh(111) surface is covered by CrOOH. So, the adsorption energy of hydrogen at the Rh(111)/CrOOH(001) interface was analyzed. Adding more CrOOH layers moves the hydrogen adsorption energy at the Rh(111)/CrOOH(001) interface more positive, making the spillover of H from the Rh(111)/CrOOH(001) interface to Cu(111) energetically favorable. The CrOOH shell allows selective permeation of protons from bulk solution to the Rh/CrOOH interface. The work function difference between Rh and Cu ensures the preferred transfer of photo-generated electrons to Rh, providing a unidirectional channel for proton reduction. Furthermore, the interface modulates the hydrogen adsorption energy on the Rh(111) surface, enabling spillover of hydrogen atoms generated in situ at the interface to nearby Cu sites. Hydrogen on Cu serves as a reductant for hydrogenation of CO₂, as shown in FIG. 8, part a.

FIG. 4, part c, shows that the CrOOH shell on top of the Rh core allows for proton transfer from the bulk solution to the Rh(111) surface. At the same time, the CrOOH film prevents other species (e.g., O₂) to approach the Ru(111) surfaces and consume the reductive H atoms generated in situ. The resulting design ensures effectiveness of the Rh/CrOx core-shell structure for photoreduction of protons.

The surface H atoms generated in situ at the Rh(111)/CrOOH(001) interface can either generate H₂ or diffuse to the Cu surface to hydrogenate CO₂. The H spillover from the Rh/CrOOH interface to the Cu(111) surface is thermodynamically allowed (FIG. 8, part a). On the Cu surface, hydrogen atoms reduce CO₂ generating the formate intermediate bound to the surface through its O atoms (bi-HCOO*). As shown in FIG. 4, part d, the bi-HCOO* intermediate leads to high selectivity of CO₂ reduction to CH₃OH.

Bader charge analysis indicates that the surface bound H atom may be better described as a hydride, as indicated by its negative charge, and is able to reduce CO₂ forming the negatively charged HCOO⁻. There are two possible pathways to reduce the bi-HCOO* with a surface H atom. One pathway is the attack on the O site, resulting in the *HCOOH intermediate. The other pathway is hydride transfer to the C site, resulting in the *OCH₂O* intermediate. Previous studies of hydrogenation of CO₂ over Cu catalysts suggest that both pathways are possible at the gas/catalyst interface. The free energy profiles for reduction of bi-HCOO* to *HCOOH and *OCH₂O* are indeed very similar without solvation. Upon considering the solvation effect, however, *HCOOH is greatly stabilized.

FIG. 8, part b, shows that the pathway via *HCOOH is thermodynamically more favorable. It is noteworthy that the *OCH₂O* intermediate, which has been suggested to be an important intermediate in gas-phase CO₂ hydrogenation over Cu catalysts, is similar to the *OCH₂O* intermediate observed upon CH₄ oxidation, indicating its role in both CH₄ oxidation and CO₂ reduction in the gas phase. In aqueous CO₂ reduction, however, *OCH₂O* is not as important as HCOOH* due to its poor water solubility.

Further reduction of the HCOOH* intermediate forms the *OCH₂OH* intermediate, which has been suggested to be important in CO₂ hydrogenation. Further reduction of *OCH₂OH* can generate both *OCH₃+*OH, or *O=CH₂+*OH₂, where the former pathway is thermodynamically favored (FIG. 8, part b). The *OCH₃ intermediate can be further reduced to CH₃OH*, leaving the Cu surface to complete the catalytic cycle.

The mechanism shown in FIG. 8 involves reduction of CO₂ by H atoms adsorbed on the Cu surface, a process equivalent to proton coupled electron transfer in electrochemical CO₂ reduction. H spillover from the Rh/CrOOH interface to the Cu surface is energetically favorable. The reduction of bi-dentate HCOO* to HCOOH* is a thermodynamically ‘uphill’ process, so the bi-dentate bound HCOO* may be a detectable intermediate by in situ spectroscopy. Reduction of CO₂ according to this mechanism thus involves hydrogenation by in situ generated H atom adsorbates, leading to high selectivity for CH₃OH production. Consistently, experiments showed CH₃OH production with no significant amounts of any kind of by-product (e.g., CO, HCOOH, H₂CO, or CH₄). Furthermore, no enhancement of CH₃OH production is observed in the presence of H₂ consistent with reducing equivalents being generated in situ.

It is useful to compare the above-described reaction mechanism with an industrial process for CH₃OH production based on hydrogenation of CO₂, catalyzed by metallic surfaces such as Cu(111), a process that requires thermal cleavage of the H—H bond at 500 K. In contrast, the example catalytic systems described herein generate H atoms in situ at room temperature on the Rh/CrOOH surface, allowing for CO₂ reduction to CH₃OH under ambient temperature and pressure (as well as other temperatures less than about, e.g., 200 degrees Celsius). FIG. 8, part b, shows that upon formation of the HCOOH* intermediate, the subsequent reaction steps are quite favorable. Therefore, formation of HCOO* represents the mechanistic bottleneck of CO₂ reduction on the Cu surface, particularly during heterogeneous CO₂ hydrogenation in the gas phase due to the large free energy cost of generating *OCH₂O*, or *HCOOH intermediates. Therefore, it is unsurprising that the industrial production of methanol from mixtures of CO/CO₂/H₂ (synthesis gas) over a Cu/ZnO/Al₂O₃ catalyst requires typical reaction conditions of 230-280 °C and 50-120 atm. Unexpectedly, the H atom adsorbates on Cu(111) can reduce CO₂ in aqueous solution, facilitating the conversion of HCOO* to HCOOH*, and thus making CH₃OH production possible under ambient temperature and pressure. In addition, the overall reaction can be driven by the in situ generated H atoms at the Rh/CrOOH interface through H spillover.

Described above are examples of photocatalytic devices and systems that can switch the mechanism of CO₂ reduction from conventional PCET of electrocatalytic systems on Cu surfaces to hydrogenation of CO₂. For catalysts consisting of Rh/CrOOH and Cu, the dominant pathway is hydrogenation of CO₂ by in situ generated H adsorbates, leading to highly selective production of CH₃OH via the HCOO* intermediate. With only Cu serving as a cocatalyst for proton reduction, both pathways are open, including PCET via *COOH and hydrogenation of CO₂ via HCOO*, leading to low selectivity with production of both H₂, CH₃OH and CH₄. The PCET pathway becomes predominant for hydrocarbon generation when applying a sufficiently negative bias potential to the Cu electrode. However, the resulting reaction still exhibits poor selectivity.

It is also useful to compare the performance of the example catalytic systems to the catalytic cofactors of natural enzymes that reduce CO₂ with high selectivity. For example, molybdoenzyme formate dehydrogenases catalyze the reduction of CO₂ to formate, while carbon monoxide dehydrogenases reversibly reduce CO₂ to CO. Remarkably, these two types of enzymes catalyze the two alternative pathways of CO₂ reduction observed on Cu electrodes with catalytic nanowires, including hydrogenation of CO₂ via the HCOO* intermediate and the PCET through the *COOH reaction intermediate.

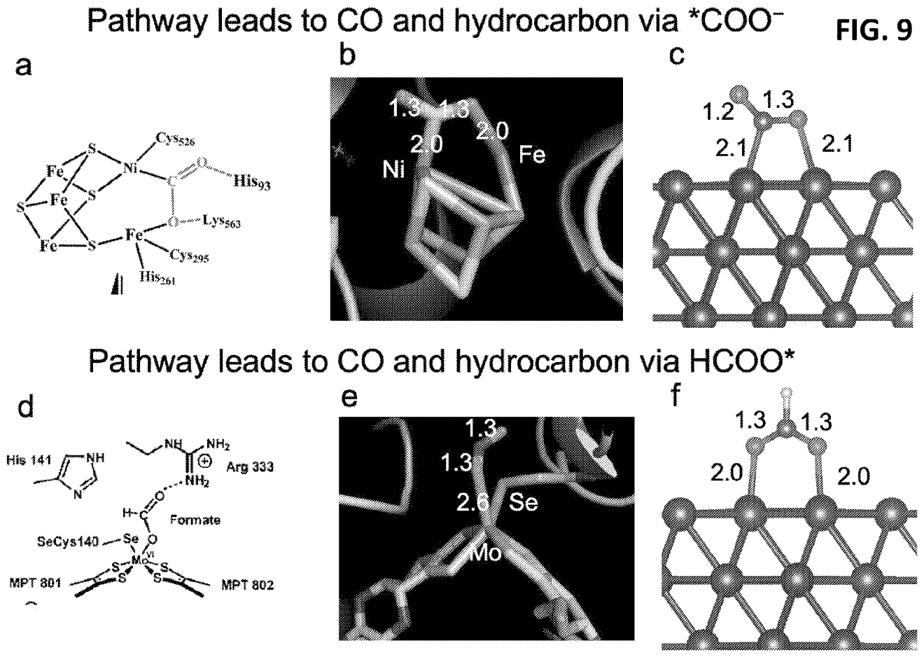

FIG. 9 shows the binding modes of CO₂ in the two enzymes, the relevant intermediates characterized by X-ray crystallography, as compared to the optimized CO₂-bound intermediate on the Cu (111) surface. The pathway leading to formation of CO in both CO dehydrogenases and the Cu surface involves the *COO-intermediate. In contrast, the pathway leading to formation of formate involves HCOO*. The C—O bond lengths of *COO-bound to the Cu(111) surface agree with those in the [Ni—Fe] CO dehydrogenase, where the CO₂ is bound at the active site with C and O coordinated to two nearby metal centers. While no CO₂-bound intermediate has been characterized by X-ray crystallography for formate dehydrogenases, a crystallographic model structure of the complex of formate dehydrogenase and nitrite is available, providing insights on the binding mode of CO₂ in formate dehydrogenase since NO₂⁻ and HCOO⁻ are isoelectronic.

FIG. 9, parts e and f, show that intermediates with CO₂ bound to metal centers through O atoms in both the enzyme active sites and the Cu surface led to hydride transfer and formation of formate. The main difference when comparing the binding modes of NO₂⁻ and HCOO⁻ is that NO₂ (and presuming HCOO-) binds to [Mo]-formate dehydrogenase as a mono-dentate O binding mode ligand, while HCOO⁻ binds to the Cu(111) surface and exhibits a bi-dentate O binding motif. Beyond these small differences in binding modes, the comparison shows that the selectivity of CO₂ reduction for one or the other reaction pathway can be tuned by tuning the specific binding mode of CO₂ to the active site in either the catalytic cofactor in the natural enzyme or the synthetic catalysts. In the example catalytic systems described herein, selectivity toward CH₃OH is achieved by introducing bi-metallic active sites that play specific functional roles during the photochemical CO₂ reduction.

PCET and hydrogen atom transfer are two different ways to deliver a reducing equivalent to CO₂ during the reduction reaction. Beyond CO₂ reduction, the PCET mechanism is ubiquitous in electrochemical, photoelectrochemical, and photochemical reactions in aqueous solutions. In contrast, hydrogen-atom transfer is more important in gas phase reactions, and in non-polar solutions. The example Rh/Cu/Cr systems described herein, however, operate in aqueous solutions and suppress PCET on the Cu surface by enabling the unidirectional flow of photoelectrons from GaN to Rh. The shell of CrOOH allows for directional proton transfer from the bulk solution to the Rh surfaces. The two directional processes enable the generation of reducing equivalents at the Rh/CrOOH interface leading to hydrogenation of CO₂ upon hydrogen spillover from Rh to Cu.

The incorporation of two metals with different work functions is useful for establishing directionality of electron transfer, while CrOOH has OH groups between layers that enable effective proton translocation through a Grotthus-type mechanism, as commonly observed in biological systems. The CrOOH film also serves as an effective membrane that allows proton transfer from the bulk solution to the electrode surface while blocking other species (e.g., O₂) that could compete with proton during the reduction reaction. Therefore, directional proton and electron transfer pathways are provided in the Rh/Cu/Cr systems described herein, providing a biomimetic system and inspiration for development of catalysts materials for selective chemical transformation.

The examples described above show that catalytic materials based on Rh/Cu/CrOOH nanoparticles dispersed on InGaN/GaN surfaces enable in-situ generation of hydrogen atoms on the Rh surface that spillover Cu where CO₂ is selectively reduced by hydrogenation to methanol with high production rate and selectivity. A record-high activity of 37.38 μmol·cm⁻²·h⁻¹ and a maximum solar-to-fuel conversion efficiency of 0.29% was achieved. The reported results demonstrate an unrivaled artificial photocatalytic configuration for unitary production of methanol and hydrogen from visible light using CO₂ and water as the only chemical inputs.

In the examples of FIGS. 3-9, InGaN/GaN nanowire arrays were grown on a silicon wafer using a plasma-assisted MBE system. The catalyst-free nanowire growth was carried out under a nitrogen-rich environment to promote formation of N-terminated surfaces protected against photo corrosion and oxidation. The nanowires, including multiple segments of InGaN/GaN, were doped with a p-type magnesium dopant. Ga and In beam equivalent pressures (BEPs) were set at about 7.35×10⁻⁸ Torr and about 7×10⁻¹⁰ Torr, respectively, and the growth temperature of InGaN was about 765 °C.

In the examples of FIGS. 3-9, Rh, Cr₂O₃, and Cu co-catalyst nanoparticles were loaded on InGaN/GaN nanowires by photo deposition. The InGaN/GaN wafer was firstly stabilized on a Teflon holder. Then the holder was transferred to a reaction chamber containing 50 mL of 20 vol % methanol aqueous solution. 5 μL of 0.2 mol L⁻¹ Na₃RhCl₆ (Sigma-Aldrich), 5 μL of 0.2 mol L⁻¹ K₂CrO₄ (Sigma-Aldrich), and 5 μL of 0.2 mol L⁻¹ CuCl₂·2H₂O (Sigma-Aldrich) were added to the solution. The chamber was covered by a quartz cover and vacuumized. The chamber was irradiated under 300 W Xe lamp (Cermax, PE 300BUV) for 30min²³ . Finally, the obtained photocatalyst wafer was soaked in 70 °C deionized water under vacuum for 10 min and dried at 80 °C in vacuum.

In the examples of FIGS. 3-9, the photo-reduction of CO₂ was performed in a glass chamber (diameter, 80 mm; volume, 400 mL) sealed with a top quartz window under 300 W xenon lamp illumination. Both AM1.5G filter and 400 nm long pass filters were inserted between the lamp and the reaction chamber. Prior to illumination, 50 mL of distilled water was purged with high-purity CO₂ (PurityPlus, 99.8%) for 15 minutes and then poured into the chamber. Subsequently, the chamber was vacuumized to further remove any gas in the water. The chamber was then filled with high-purity CO₂ (99.8%), and purged with CO₂ for 10 minutes. Before illumination, the chamber was placed in a water bath bed to stabilize the temperature. After 10 minutes, the lamp was mounted on the reaction chamber to start illumination. During the stability test, at an interval of 1 hour, the sample was taken out of the reaction chamber, exposed to air, rinsed with deionized water, and dried in CO₂ flow to get rid of the methanol adsorbed on the surface. The chamber was also thoroughly cleaned. The next cycle of the reaction was then conducted to test the device stability.

Described above are examples of the conversion of CO₂ into liquid fuels, using only sunlight and water, thereby offering a promising path to carbon neutrality. The examples address the challenges of achieving high efficiency and product selectivity. Examples are described that utilize a wireless photocatalytic architecture for conversion of CO₂ and water into methanol and oxygen. The catalytic architecture may include semiconducting nanowires decorated with core-shell nanoparticles, with a copper-rhodium core and a chromium oxide shell. The Rh/CrOOH interface provides a unidirectional channel for proton reduction, enabling hydrogen spillover at the core-shell interface, as shown by density functional theory. The vectorial transfer of protons, electrons, and hydrogen atoms allows for switching the mechanism of CO₂ reduction from a proton-coupled electron transfer pathway in aqueous solution to hydrogenation of CO₂ with a record high solar-to-methanol efficiency of 0.29%. The examples described above demonstrate a highly efficient, stable, and scalable wireless system for synthesis of methanol from CO₂ that provide a viable path towards carbon neutrality and environmental sustainability.

The term “about” is used herein in a manner to include deviations from a specified value that would be understood by one of ordinary skill in the art to effectively be the same as the specified value due to, for instance, the absence of appreciable, detectable, or otherwise effective difference in operation, outcome, characteristic, or other aspect of the disclosed methods and devices.

The present disclosure has been described with reference to specific examples that are intended to be illustrative only and not to be limiting of the disclosure. Changes, additions and/or deletions may be made to the examples without departing from the spirit and scope of the disclosure.

The foregoing description is given for clearness of understanding only, and no unnecessary limitations should be understood therefrom.

What is claimed is:

1. A catalytic device comprising:
a substrate; and
an array of conductive projections supported by the substrate and extending outward from the substrate;
wherein each conductive projection of the array of conductive projections is decorated with a co-catalyst arrangement, the co-catalyst arrangement being configured to convert carbon dioxide (CO₂) via hydrogenation in aqueous solution.

2. The catalytic device of claim 1, wherein the co-catalyst arrangement has a bi-metallic composition.

3. The catalytic device of claim 1, wherein the co-catalyst arrangement is disposed in a core-shell configuration.

4. The catalytic device of claim 1, wherein the co-catalyst arrangement comprises:
a first metallic nanoparticle;
a second metallic nanoparticle adjacent the first nanoparticle, the second nanoparticle having a different composition than the first metallic nanoparticle; and
an oxide shell covering an outer surface of the first metallic nanoparticle;
wherein the oxide shell is configured to allow the carbon dioxide (CO₂) to reach an outer surface of the second metallic nanoparticle.

5. The catalytic device of claim 4, wherein the oxide shell does not cover the outer surface of the second metallic nanoparticle.

6. The catalytic device of claim 4, wherein:
the first metallic nanoparticle comprises a first metal;
the second metallic nanoparticle comprises a second metal; and
the second metal has a larger lattice mismatch with an oxide material of the oxide shell than the first metal.

7. The catalytic device of claim 4, wherein:
the first metallic nanoparticle is configured to reduce protons in the aqueous solution to hydrogen atoms; and
the first metallic nanoparticle and the second metallic nanoparticle are arranged such that the hydrogen atoms diffuse from the first metallic nanoparticle to the second metallic nanoparticle to hydrogenate the carbon dioxide (CO2) present at the outer surface of the second metallic nanoparticle.

8. The catalytic device of claim 4, wherein:
the first metallic nanoparticle comprises rhodium; and
the second metallic nanoparticle comprises copper.

9. The catalytic device of claim 1, wherein the oxide shell comprises chromium oxide.

10. The catalytic device of claim 1, wherein:
each conductive projection of the array of conductive projections has a semiconductor composition; and
the semiconductor composition is configured for charge carrier generation in response to solar radiation.

11. The catalytic device of claim 1, wherein:
each conductive projection of the array of conductive projections has a semiconductor composition; and
the semiconductor composition comprises a III-nitride semiconductor material.

12. A method of using the catalytic device of claim 1, the method comprising:
immersing the catalytic device in the aqueous solution;
illuminating the catalytic device with incident light radiation; and
capturing a liquid product of a CO₂ reduction reaction catalyzed by the catalytic device.

13. The method of claim 12, wherein the aqueous solution is unheated.

14. The method of claim 12, wherein the catalytic device is illuminated without application of a bias voltage to the catalytic device.

15. The method of claim 12, wherein the aqueous solution is free of a sacrificial agent for the CO2 reduction reaction.

16. The method of claim 12, wherein immersing the catalytic device in the aqueous solution is implemented at a temperature less than 200 degrees Celsius.

17. A catalytic device comprising:
a substrate; and
an array of conductive projections supported by the substrate and extending outward from the substrate;
wherein each conductive projection of the array of conductive projections is decorated with a co-catalyst arrangement, and wherein the co-catalyst arrangement comprises:
a first metallic nanoparticle;
a second metallic nanoparticle adjacent the first nanoparticle, the second nanoparticle having a different composition than the first metallic nanoparticle; and
an oxide shell covering an outer surface of the first metallic nanoparticle and exposing an outer surface of the second metallic nanoparticle.

18. The catalytic device of claim 17, wherein:
the first metallic nanoparticle comprises a first metal;
the second metallic nanoparticle comprises a second metal; and
the second metal has a larger lattice mismatch with an oxide material of the oxide shell than the first metal such that the oxide shell does not cover the second metallic nanoparticle.

19. The catalytic device of claim 17, wherein:
the first metallic nanoparticle comprises rhodium;
the second metallic nanoparticle comprises copper; and
the oxide shell comprises chromium oxide.

20. A method of fabricating a photocatalytic device, the method comprising:
providing a substrate having a surface;
forming an array of conductive projections on the substrate such that each conductive projection of the array of conductive projections extends outward from the substrate, each conductive projection of the array of conductive projections having a semiconductor composition configured for charge carrier generation in response to light radiation; and
decorating each conductive projection of the array of conductive projections with a co-catalyst arrangement,
wherein decorating each conductive projection comprises depositing first metallic nanoparticles, second metallic nanoparticles, and an oxide material on each conductive projection to dispose the co-catalyst arrangement in a core-shell configuration.

21. The method of claim 20, wherein depositing the first metallic nanoparticles, the second metallic nanoparticles, and the oxide material comprises implementing a photo-deposition procedure.

22. The method of claim 20, wherein forming the array of conductive projections comprises growing the array of conductive projections under a nitrogen-rich environment.

23. A photocatalytic device comprising:
a substrate; and
an array of conductive projections supported by the substrate and extending outward from the substrate, each conductive projection of the array of conductive projections having a composition configured for charge carrier generation in response to light irradiation;
wherein each conductive projection of the array of conductive projections is decorated with a co-catalyst arrangement, the co-catalyst arrangement being configured to convert carbon dioxide (CO₂) via hydrogenation in connection with the light irradiation.
